(19) United States
(12) Patent Application Publication
(10) Pub. No.: US 2017/0017410 A1
(43) Pub. Date: Jan. 19, 2017

(54) MEMORY CONTROLLER

(71) Applicant: SK hynix Inc., Gyeonggi-do (KR)

(72) Inventors: Jong-Bum Park, Gyeonggi-do (KR); Yong-Kee Kwon, Gyeonggi-do (KR); Yong-Ju Kim, Gyeonggi-do (KR)

(21) Appl. No.: 14/981,387

(22) Filed: Dec. 28, 2015

(30) Foreign Application Priority Data
Jul. 15, 2015 (KR) 10-2015-0100275

(51) Int. Cl. G06F 3/06

(52) U.S. Cl. CPC G06F 3/0611; G06F 3/0659; G06F 3/0673

(57) ABSTRACT

A memory controller includes: a write performance storage circuit suitable for storing write performance indexes of physical memory areas of a memory device, a write counting circuit suitable for counting a number of requests of a write operation on logical memory areas of the memory device, and a mapping circuit suitable for mapping a logical memory area, for which the number of requests of the write operation r may be relatively large, to a physical memory area with a better write performance index.

### CROSS-REFERENCE TO RELATED APPLICATIONS

The present application claims priority of Korean Patent Application No. 10-2015-0100275, filed on Jul. 15, 2015, which is incorporated herein by reference in its entirety.

### BACKGROUND

1. Field

Various embodiments of the present invention relate to a memory device a memory controller, a memory system including the same and a method of operation thereof.

2. Description of the Related Art

Memory devices are required to operate at a high speed. A write recovery time (tWR), may be typically included in the specification of a memory device. The write recovery time indicates a period of time from when a write operation may be performed and data may be stored in a memory cell of a memory device to when the stored data is not affected by a precharge operation. That is, the write recovery time indicates a minimum period of time required to normally store data in a memory cell of a memory device from when a write command may be applied. A memory controller should apply a precharge command to the memory device after the lapse of a time more than the write recovery time from when the write command is applied. Hence, the shorter the write recovery time, the earlier the memory cell can be precharged for another operation resulting in improved speed and performance.

Due to increasing miniaturization of memory fabrication processes, contact resistance formed in a memory device may increase causing the write recovery time to increase. Furthermore, the write recovery time may vary for different areas of a memory device due to process variations and the like. Accordingly, for improved performance, it may be desirable to prevent the write recovery time of a memory device from increasing and/or changing between different areas of the memory device.

### SUMMARY

Various embodiments are directed to a memory system that may improve the write operation performance thereof.

In an embodiment a memory controller may include: a write performance storage circuit suitable for storing write performance indexes of one or more physical memory areas of a memory device; a write counting circuit suitable for counting a number of write operation requests for one or more logical memory area of the memory device; and a mapping circuit suitable for mapping a logical memory area for which the number of the write operation requests is relatively large to a physical memory area with a relatively better write performance index.

Mapping information of the mapping circuit may be updated, the memory controller may control data stored in the physical areas of the memory to be migrated according to the updated mapping.

The mapping of the mapping circuit may be periodically updated.

The write performance index may include a write recovery time (tWR), and the memory controller may differentially apply a write recovery time regulation to the physical areas of the memory.

The physical areas of the memory may include banks.

The write performance storage circuit may receive the write performance indexes of physical areas from the memory and store the write performance indexes.

In an embodiment of the present invention, a memory system may include: a memory device including one or more physical memory areas, and a memory controller suitable for controlling the memory device; the memory controller including a write performance storage circuit suitable for storing write performance indexes of the physical memory areas; a write counting circuit suitable for counting a number of requests of a write operation on logical memory areas of the memory device; and a mapping circuit suitable for mapping a logical memory area, for which the number of requests of the write operation is larger to a physical memory area with a better write performance index.

In an embodiment of the present invention, an operation method of a memory controller may include: counting a number of requests of a write operation on logical memory areas of a memory device; mapping a logical memory area, for which the number of requests of the write operation is large, to a physical memory area with a better write performance index among physical memory areas of the memory device; and controlling the memory device such that data stored in the physical memory areas of the memory device is migrated based on mapping information.

The mapping and the controlling of the memory may be periodically performed

The operation method of the memory controller may further include receiving write performance indexes of the physical areas from the memory and storing the write performance indexes.

The write performance index may include a write recovery time (tWR), and the physical areas of the memory may include banks.

### BRIEF DESCRIPTION OF THE DRAWINGS

FIG. 1 is a diagram illustrating a memory system, according to an embodiment of the invention.

FIG. 2 is a table illustrating a write performance index according to physical memory areas of a memory device, which may be stored in a write performance storage circuit shown in FIG. 1, according to an embodiment of the invention.

FIG. 3 is a table illustrating the number of requests of a write operation on logical memory areas, which is counted by a write counting circuit shown in FIG. 1, according to an embodiment of the invention.

FIG. 4 is a table illustrating initial mapping information of a mapping circuit shown in FIG. 1, according to an embodiment of the invention.

FIG. 5 is a table illustrating mapping information after the mapping of the mapping circuit may be updated, according to an embodiment of the invention.

FIG. 6 is a flow chart describing an operation of the memory system shown in FIG. 1, according to an embodiment of the invention.

### DETAILED DESCRIPTION

Various embodiments will be described below in more detail with reference to the accompanying drawings. The present invention may, however, be embodied in different forms and should not be construed as limited to the embodiments set forth herein. Rather, these embodiments are provided so that this disclosure will be thorough and complete, Throughout the disclosure, like reference numerals refer to like parts throughout the various figures and embodiments of the present invention.

The drawings are not necessarily to scale and, in some instances, proportions may have been exaggerated to clearly illustrate features of the embodiments. It may be also noted that in this specification, “connected/coupled” refers to one component not only directly coupling another component, but also indirectly coupling another component through an intermediate component.

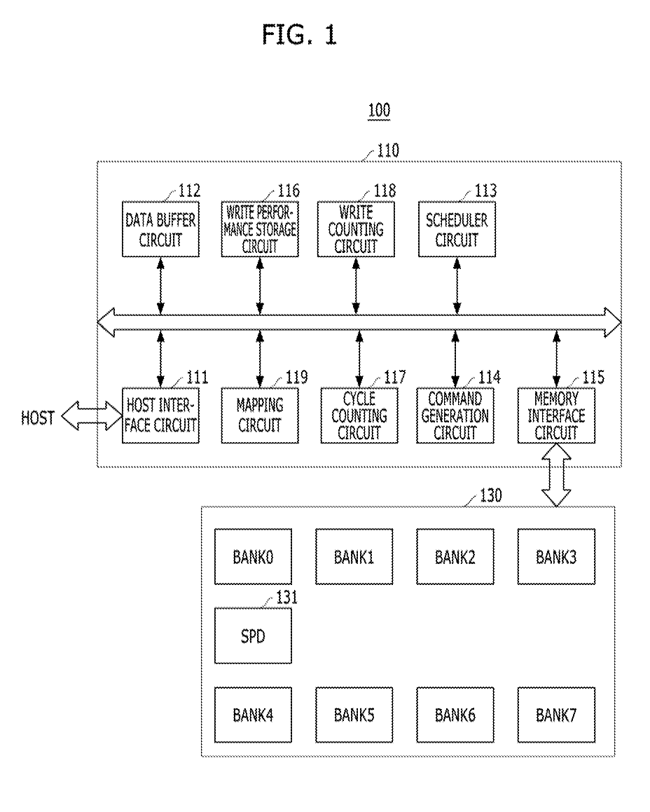

FIG. 1 is a diagram illustrating a memory system 100 according to an embodiment of the present invention.

Referring now to FIG. 1, the memory system 100 may include a memory controller 110 and a memory device 130. In FIG. 1, the memory system 100 may communicate with a host.

The memory device 130 may perform read and write operations under the control of the memory controller 110. The memory device 130 may include a plurality of physical memory areas BANK0 to BANK7 that store data, The physical memory areas BANK0 to BANK7 may be banks. The memory device 130 may include a circuit 131 that stores information for an operation of the memory device 130. The circuit 131 may be referred to as SPD (Serial Presence Detect). The information on various parameters, such as information on the capacity of the memory device 130, may be stored in the SPD 131 and may be provided to the memory controller 110. The SPD 131 may store write performance indexes of the physical memory areas BANK0 to BANK7 of the memory device 130. A write performance index may be or comprise a write recovery time (tWR). In the manufacturing process of the memory device 130, a test may be performed for various types of performance of the memory device 130 by a memory manufacturer. In this process, the write recovery times (tWR) for the physical memory areas BANK0 to BANK7 of the memory device 130 may be measured and stored in the SPD 131. Alternatively, write performance for the physical memory areas BANK0 to BANK7 of the memory device 130 may be tested by a test operation controlled by the memory controller 110, and thus the write recovery times (tWR) for the physical memory areas BANK0 to BANK7 may also be measured and stored in the SPD 131. The memory device 130 illustrated in FIG. 1 may also comprise one memory chip or a memory module (for example, DIMM) including a plurality of memory chips.

The memory controller 110 may control the operation of the memory device 130 according to a request from the host HOST. The memory controller 110 may include a host interface circuit 111, a data buffer circuit 112, a scheduler circuit 113, a command generation circuit 114, a memory interface circuit 115, a write performance storage circuit 116, a cycle counting circuit 117, a write counting circuit 118, and a mapping circuit 119.

The host interface circuit 111 may provide an interface between the memory controller 110 and the host. Through the host interface circuit 111, requests of the host may be received from the host, and processing results by the requests of the host may be transmitted to the host.

The data buffer circuit 112 may temporarily store data to be written to the memory device 130 and data read from the memory device 130.

The scheduler circuit 113 may determine an order for requests to be instructed to the memory device 130 from requests received from the host. The scheduler circuit 113 may allow an order in which the requests have been received from the host and an order of operation instructed to the memory device 130 to be different from each other in order to improve the performance of the memory system 100. For example, even though the host requests a read operation of the memory device 130 and then requests a write operation, the scheduler circuit 113 may adjust an order such that the write operation of the memory device 130 may be performed before the read operation.

The command generation circuit 114 may generate a command to be applied to the memory device 130 according to the operation order decided by the scheduler circuit 113.

The memory interface circuit 115 may provide an interface between the memory controller 110 and the memory device 130. Through the memory interface circuit 115, commands and addresses may be transferred from the memory controller 110 to the memory device 130, and data may be exchanged between the memory controller 110 and the memory device 130. Furthermore, through the memory interface circuit 115, information stored in the SPD 131 of the memory device 130 may be transferred to the memory controller 110. The memory interface circuit 115 may also be called a PHY interface.

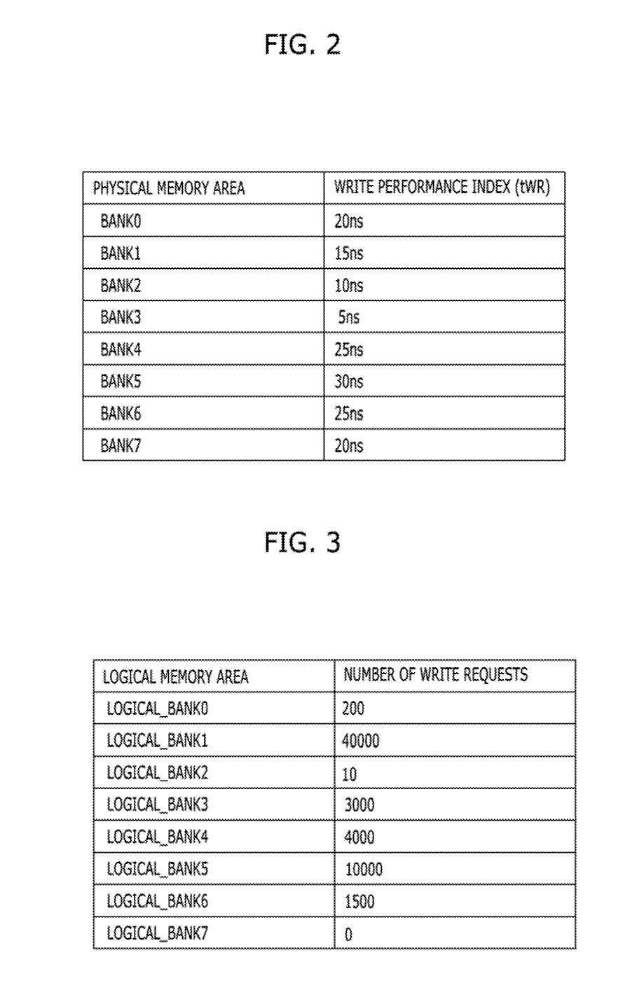

The write performance storage circuit 116 may store write performance indexes (for example, tWR) for the physical memory areas BANK0 to BANK7 of the memory device 130. The write performance storage circuit 116 may receive write performance indexes for the physical memory areas BANK0 to BANK7 from the SPD 131 of the memory device 130, and store the received write performance indexes. Furthermore, write performance indexes for the physical memory areas BANK0 to BANK7 of the memory, which have been measured by performing a test operation for the memory device 130 by the memory controller 110, may also be stored in the write performance storage circuit 116. FIG. 2 illustrates the write performance indexes according to the physical memory areas of the memory device, which may be stored in the write performance storage circuit 116, according to an embodiment of the invention

The cycle counting circuit 117 may decide an update cycle of the mapping circuit 119. The cycle counting circuit 117 may count the number of activations of a periodic wave (for example, a clock), and may inform the mapping circuit 119 of a mapping update time whenever the counted number reaches a predetermined value.

The write counting circuit 118 may count the number of write operation requests received from the host for the logical memory areas (for example, logical banks) of the memory device. The logical memory areas may also be mapped with the physical memory areas BANK0 to BANK7 by the mapping circuit 119. FIG. 3 illustrates the number of write operation requests for each logical memory area LOGICAL_BANK0 to LOGICAL_BANK7, which have been counted by the write counting circuit 118. Among the logical memory areas LOGICAL_BANK0 to LOGICAL_BANK7, an area for which the number of the write operation requests is large, may be estimated as an area for which write operation operations may be expected to be large later. Written operation requests are considered to be large for a bank if they exceed a predefined value.

The mapping circuit 119 may map the logical memory areas LOGICAL_BANK0 to LOGICAL_BANK7 based on the host and the physical memory areas BANK0 to BANK7 based on the memory device. The mapping information of the mapping circuit 119 may be updated at an update time notified from the cycle counting circuit 117. The mapping circuit 119 may map an area, for which the number of write operation requests may be large among the logical memory areas LOGICAL_BANK0 to LOGICAL_BANK7, as an area with a better write performance index among the physical memory areas BANK0 to BANK7.

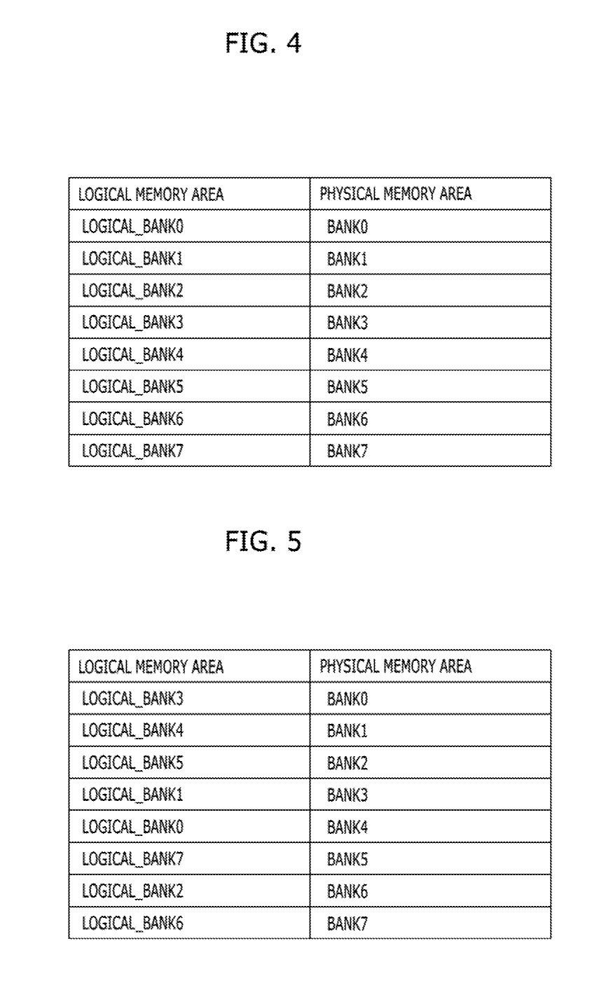

FIG. 4 shows initial mapping information of the mapping circuit 119 shown in FIG. 1, according to an embodiment of the invention. Referring to FIG. 4, the logical memory areas LOGICAL_BANK0 to LOGICAL_BANK7 are mapped to the physical memory areas BANK0 to BANK7 with the same numbers. FIG. 5 shows updated mapping information after the mapping circuit 119 is updated, Referring to FIG. 5, a logical memory area, for which the number of write operation requests is large among the logical memory areas LOGICAL_BANK0 to LOGICAL_BANK7, may be mapped to a physical memory area (i.e., an area with less tWR) with a better write performance index among the physical memory areas BANK0 to BANK7.

When the logical memory areas LOGICAL_BANK0 to LOGICAL_BANK7 and the physical memory areas BANK0 to BANK7 are mapped with each other as illustrated in FIG. 5, since great number of write operations are performed in an area (for example, BANK 3) with a better write performance index and less number of write operations are performed in an area (for example, BANK 5) with a poor write performance index, it may be possible to ensure a stable operation of the memory device 130. Furthermore, the memory controller 110 may differentially assign a write recovery time (WR) for the respective physical memory areas BANK0 to BANK7, thereby enabling performance improvement. For example the memory controller 110 may apply a write command to the physical memory area BANKS and then apply a precharge command after the lapse of only 5 ns, thereby performing a subsequent operation, Furthermore, the memory controller 110 may apply a write command to the physical memory area BANKS and then apply a precharge command after the lapse of 30 ns.

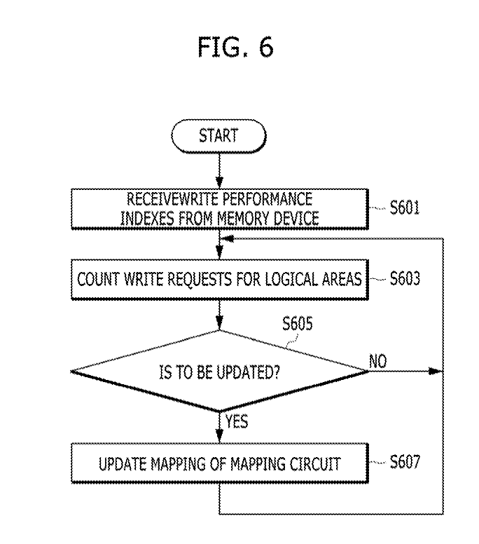

FIG. 6 provides a flow chart describing an operation of the memory system 100 shown in FIG. 1, according to an embodiment of the invention.

Referring to FIG. 6, at step S601 the memory controller 110 may receive write performance indexes of the physical memory areas BANK0 to BANK7 from the memory device 130 and store the write performance indexes in the write performance storage circuit 116. At step S603, the write counting circuit 118 of the memory controller 110 may count the number of write requests for the logical memory areas LOGICAL_BANK0 to LOGICAL_BANK7 of the host.

At step S605, it may be determined by the cycle counting circuit 117 whether the mapping circuit 119 may be updated (i.e., whether an update point in time for the mapping circuit 119 has reached), and when the update time point has not reached, step S603 may be performed again. When the update time point has reached, the mapping information of the mapping circuit 119 may be updated at step S607. The mapping update of the mapping circuit 119 may be performed in such a manner that an area, for which the number of write operation requests may be large or relatively large among the logical memory areas LOGICAL_BANK0 to LOGICAL_BANK7, may be mapped to an area with a better write performance index among the physical memory areas BANK0 to BANK7. The number of operation requests may be relatively large if it is higher than a median value for a selected group of logical areas. The number of operation requests may be relatively large if it is higher than an average value for a selected group of logical areas. In an embodiment, the logical area with the highest number of operation requests may be selected and mapped with a physical memory area having a relatively small write performance index or with the physical memory area having the smallest write performance index.

Although various embodiments have been described for illustrative purposes, it will be apparent to those skilled in the art that various changes and modifications may be made without departing from the spirit and scope of the invention as defined in the following claims.

What is claimed is:

1. A memory controller comprising:
a write performance storage circuit suitable for storing write performance indexes of one or more physical memory areas of a memory device;
a write counting circuit suitable for counting a number of write operation requests for one or more logical memory area of the memory device; and
a mapping circuit suitable for mapping a logical memory area for which the number of the write operation requests is relatively large to a physical memory area with a relatively better write performance index.

2. The memory controller of claim 1, wherein mapping information of the mapping circuit is updated, and the memory controller controls data stored in the physical memory areas of the memory device to be migrated according to the updated mapping information.

3. The memory controller of claim 1, wherein mapping information of the mapping circuit periodically updated.

4. The memory controller of claim 1, wherein the write performance indexes include a write recovery time (tWR).

5. The memory controller of claim 4, wherein the memory controller differentially assigns a write recovery time for the respective physical memory areas of the memory device.

6. The memory controller of claim 1, wherein the one or more physical memory areas of the memory device include banks.

7. The memory controller of claim 1, wherein the write performance storage circuit receives the write performance indexes for the respective physical memory areas from the memory device for storing the write performance indexes therein.

8. A memory system comprising:
a memory device including one or more physical memory areas and
a memory controller suitable for controlling the memory device; the memory controller comprising: a write performance storage circuit suitable for storing write performance indexes of the physical memory areas;
a write counting circuit suitable for counting a number of requests of a write operation on logical memory areas of the memory device; and
a mapping circuit suitable for mapping a logical memory area, for which the number of requests of the write operation is larger to a physical memory area with a better write performance index.

9. The memory system of claim 8, wherein, when mapping information of the mapping circuit is updated, the memory controller controls data stored in the physical memory areas of the memory device to be migrated according to the changed mapping information.

10. The memory system of claim 8, wherein the mapping circuit is periodically updated.

11. The memory system of claim 8, wherein the write performance indexes include a write recovery time (tWR).

12. The memory system of claim 11, wherein the memory controller differentially assigns a write recovery time for the respective physical memory areas of the memory device.

13. The memory system of claim 8, wherein the physical memory areas of the memory device include banks.

14. The memory system of claim 8, wherein the write performance storage circuit receives the write performance indexes for the respective physical memory areas from the memory device to store the write performance indexes herein.

15. An operation method memory controller, comprising:
counting a number of requests of a write operation on logical memory areas of a memory device;
mapping a logical memory area, for which the number of requests of the write operation is large, to a physical memory area with a better write performance index among physical memory areas of the memory device; and
controlling the memory device such that data stored in the physical memory areas of the memory device is migrated based on mapping information.

16. The operation method of claim 15, wherein the mapping of the logical memory area and the controlling of the memory device are periodically performed.

17. The operation method of claim 15, further comprising:
receiving write performance indexes for the respective physical memory areas from the memory device to store the write performance indexes.

18. The operation method m of claim 15, wherein the write performance indexes include a write recovery time (tWR).

19. The operation method of claim 15, wherein the physical memory areas of the memory device include banks.
